(19) United States
(12) Patent Application Publication
(10) Pub. No.: US 2008/0052407 A1
(43) Pub. Date: Feb. 28, 2008

(54) METHOD AND SYSTEM FOR INFORMATION BROADCASTING

(75) Inventors: DANIEL A. BAUDINO, LAKE WORTH, FL (US); JORGE L. PERDOMO, BOCA RATON, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/467,086

(22) Filed: Aug. 24, 2006

(51) Int. Cl. G06F 15/16; G06F 15/173

(52) U.S. Cl. 709/238; 709/219; 709/223

(57) ABSTRACT

A system (100) and method (200) for information broadcasting is provided. The method can include collecting (202) information for distribution to a plurality of mobile devices, adding (204) context sensitive flags to the information to produce context information, broadcasting (206) the context information to an infrastructure having communication with the plurality of mobile devices, and filtering (208) the context information based on the context sensitive flags to produce context sensitive information. A context sensitive flag (410) can identify a geographic or semantic location to deliver the context sensitive information.

### FIELD OF THE INVENTION

This invention relates generally to communications system, and more particularly to distributing information.

### BACKGROUND OF THE INVENTION

The hand-held mobile device industry is constantly challenged in the market place for products and features that allow users to be in constant communication with one another. Moreover, as users are becoming more mobile, the need to remain connected and receive information on a continual basis can be an important service quality factor. Users generally rely on their mobile devices to receive information from other users such as during emergency situations or catastrophic events. Mobile devices are supporting seamless connectivity initiatives which allow information to be shared between devices more readily, and allowing devices to be continually connected. As one example, podcasts are continual broadcasts capable of providing streaming media content thereby allowing users to receive news subscriptions or services. As another example, ad-hoc networks are allowing users to collaborate and create information sharing communities. Mobile devices, such as cell phones, are also supporting information sharing services such as broad cast services which may include blogs or other forms of distributed media.

Hand-held mobile devices can be programmed to receive several type of information using low data rate broadcasting methodology such as Dynamic Idle or high data rate broadcasting, such as DVB-H. In practice, an infrastructure channel is assigned to broadcast a specific content. For example, a server may stream a single news subscription over a single channel. Delivery of a new subscription via broadcasting generally involves assigning a new channel or system to handle the subscription. For example, if a new broadcast service is to be introduced and delivered to the user, a new server is generally deployed or a new channel is introduced on the broadcasting system. In practice, assigning new servers or channels increases complexity and service costs.

As an example of prior art broadcasting, Radio Syndication Services (RSS) is a format for syndicating news and the content of news-like sites, including major news sites, news-oriented community sites, and personal web logs. RSS also supports various other media sources which can be syndicated. For example, a “recent changes” page of a wiki, a change log of check-ins, or a revision history of a book can be continually monitored and updated. Information about each item can be placed in RSS format, and an RSS aware program can check a media distribution feed for changes. The media distribution feed can respond to modifications of the broadcast in an appropriate way. For example, a wiki page can be updated based on user reported feedback. Really Simple Syndication (RSS) is a lightweight XML format designed for sharing headlines and other Web content. It has evolved into a popular means of sharing content between sites, and gathering and distributing news.

However, delivering content on a larger scale such as a cellular network for supporting continual distribution services requires a system that is highly scalable. Moreover, users desiring to remain in constant communication may not be capable of alternating between channels or subscription services for receiving new information. Accordingly, assigning new servers or channels to new media streams is impractical and may require user input. Furthermore, there may be times when news sources may have limited channels based on emergency events. A need therefore exists for delivering information which does not require assigning new channels and which can use a current infrastructure of the cellular networks to broadcast information.

### SUMMARY OF THE INVENTION

One embodiment of the invention is directed to a method for information delivery. The method can include generating information for distribution to a plurality of mobile devices, adding context sensitive flags to the information to produce context information, broadcasting the context information to an infrastructure having communication with the plurality of mobile devices, filtering the context information based on the context sensitive flags to produce context sensitive information, and presenting the context sensitive information to at least one of the plurality of mobile devices. In one aspect, a context sensitive flag can identify a geographic or semantic location to deliver the context sensitive information. A flag can also be conditional on an occurrence of an event such that the flag is raised if the event occurs, wherein the event can be location-based or time-based. In another aspect, a context sensitive flag can be identified by a priority and having a color associated with the priority.

Another embodiment of the invention is directed to a system for information delivery. The system can include a server for collecting information for distribution to a plurality of mobile devices, adding context sensitive flags to the information to produce context information, and broadcasting the context information to the cellular network. The system can include at least one infrastructure component in the cellular network for receiving the context information, filtering the context information based on the context sensitive flags to produce context sensitive information, and sending the context sensitive information to at least one base station operated by the at least one infrastructure component. The base station in the cellular network can deliver the context sensitive information to the plurality of mobile devices. In one arrangement, the base station can filter context information based on the context sensitive flags added by the server. For example, the base station can identify a location of a mobile device and filter the context information based on the location of the mobile device. In another aspect, if a location is unavailable, the mobile device can filter the context sensitive information based on the context sensitive flags or a user configuration. The mobile device can present the context sensitive information to a user of the mobile device.

Yet another embodiment of the invention is directed to a mobile device for information delivery. The mobile device can include a transmitter for sending context information, a receiver for receiving context information having context sensitive flags, a processor for filtering the context information based on the context sensitive flags to produce context sensitive information, and a display for presenting the context sensitive information. The device can further include a global positioning system for identifying a location of the mobile device. In one aspect, a user can configure the mobile device to receive the context sensitive information such as subscribing to event information, news information, traffic information, or local information. The transmitter can send a location of the mobile device to an infrastructure component that uses the location to generate location-based context sensitive information that is delivered to the mobile device. The infrastructure component can filter context information received by a server and deliver context sensitive information related to a location of the mobile device.

### BRIEF DESCRIPTION OF THE DRAWINGS

FIG. 1 is a diagram of a cellular communication network in accordance with the embodiments of the invention;

FIG. 2 is a method for information broadcasting in accordance with the embodiments of the invention;

FIG. 3 is schematic of a mobile device in accordance with the embodiments of the invention;

FIG. 4 is a format for context sensitive information in accordance with the embodiments of the invention;

FIG. 5 is an illustration for information broadcasting based on context sensitive information in accordance with the embodiments of the invention; and

FIG. 6 is a format for location-based context sensitive information in accordance with the embodiments of the invention;

FIG. 7 is a format for advisory-based context sensitive information in accordance with the embodiments of the invention;

FIG. 8 is a format for priority-based context sensitive information in accordance with the embodiments of the invention;

FIG. 9 is a format for conditional-based context sensitive information in accordance with the embodiments of the invention;

FIG. 10 is an illustration for security-based information broadcasting in accordance with the embodiments of the invention; and

FIG. 11 is an illustration for collaborative information broadcasting in accordance with the embodiments of the invention.

### DETAILED DESCRIPTION OF THE DRAWINGS

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely. The term “processor” can be defined as any number of suitable processors, controllers, units, or the like that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Broadly stated, embodiments of the invention are directed to delivering context information using a single broadcasting server. The single broadcasting server can collect information from various sources and add flags to identify a context of the information. The context information can include location sensitive information, information relevant to driving context such as traffic, and user context such as news or entertainment, but is not herein limited to these. In one aspect, context information can be directed to a mobile device based on a location of the device. The broadcasted information can be generated at a server and distributed to mobile devices. The server can add context sensitive flags that, such that when the context information is broadcast, a receiving infrastructure can filter the content based on the context sensitive flags and deliver context information relevant to the user. The context sensitive information can be broadcasted information, location-based information, home land security information, priority information, emergency information, weather information, traffic information, channel subscription, or news.

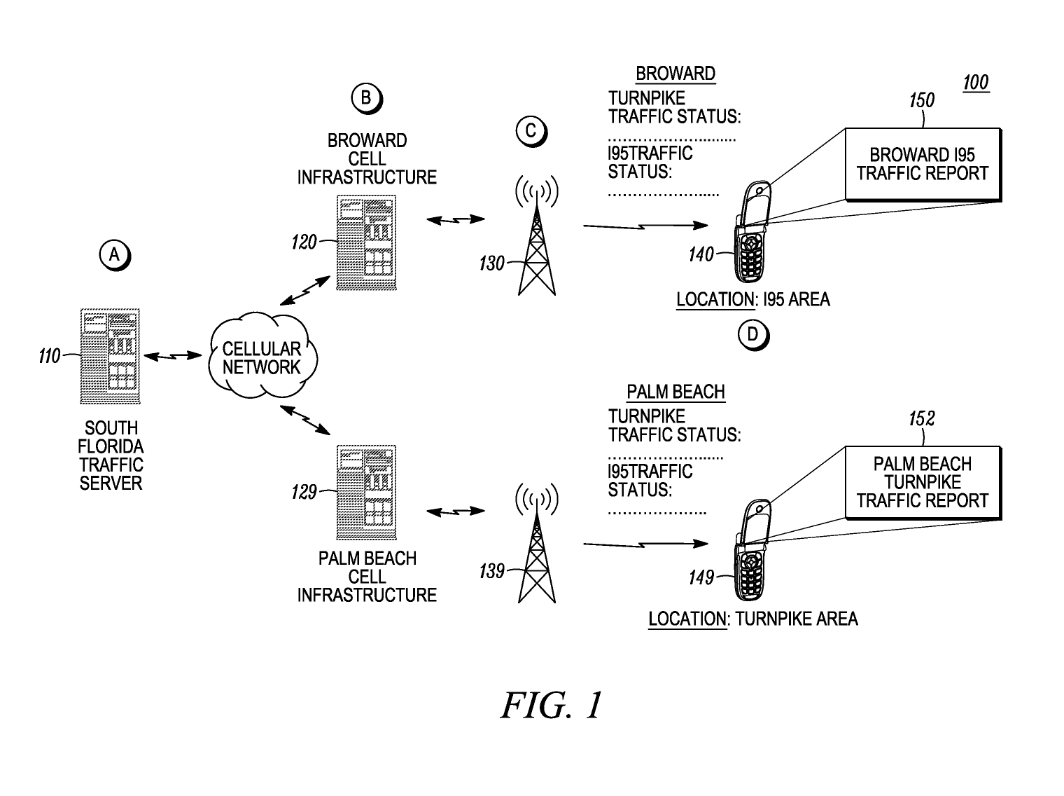

Referring to FIG. 1, an illustration of a cellular communication system 100 in accordance with the embodiments of the invention is shown. The cellular communication system 100 can comprise a server 110, at least one infrastructure component 120, at least one base receiver 130, and at least one mobile device 140. The server 110 can communicate information to the one or more infrastructure components (120 and 129) which can filter the data and send the data via base stations (130 and 139) to one or more mobile devices (140 and 149). Notably, more or less than the number of components shown can be included in the communication system 100.

The cellular communication system 100 can provide wireless connectivity over a radio frequency (RF) communication network such as the base station 130, also known as a tower. The base station 130 may also be a base receiver, a central office, a network server, or any other suitable communication device or system for communicating with the one or more mobile devices. The mobile device 140 can communicate with one or more cellular towers 130 using a standard communication protocol such as Orthogonal Frequency Division Multiplexing (OFDM), Time Division Multiple Access (TDMA), Global Systems Mobile (GSM), or integrated Dispatch Enhanced Network (iDEN) Universal mobile Telecommunication Systems (UMTS), IEEE802.11 or IEEE802.16 technologies, though is not limited to these. The base station 130 can be part of a cellular infrastructure or a radio infrastructure containing standard telecommunication equipment as is known in the art.

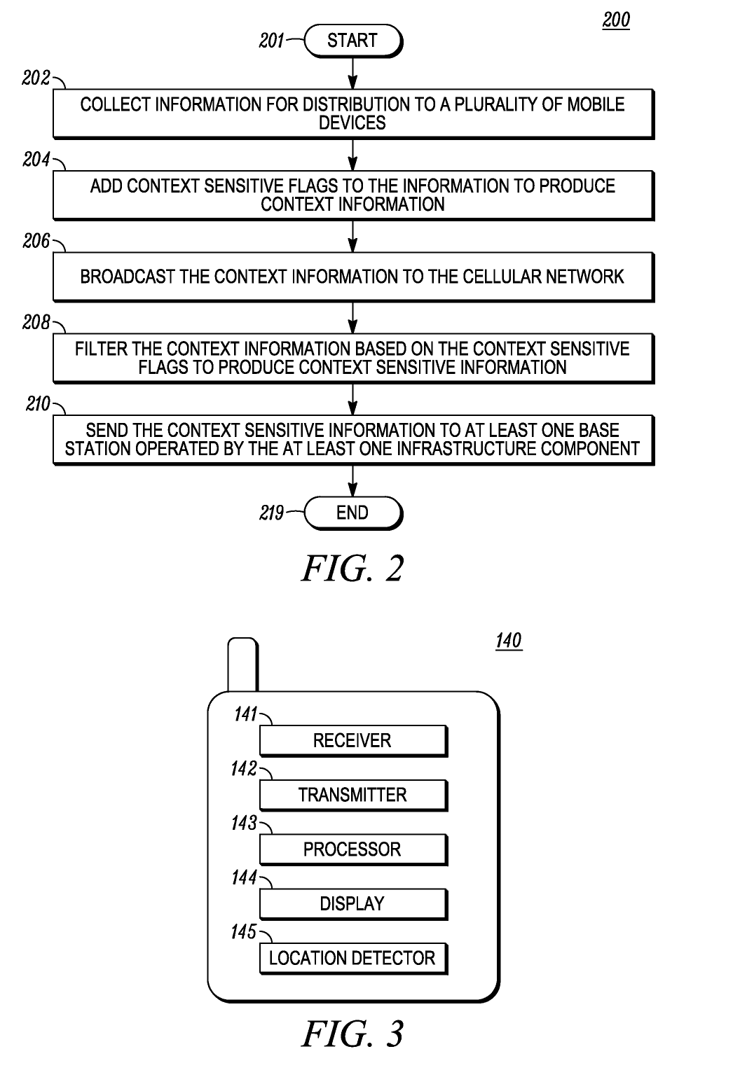

Briefly referring to FIG. 2, a method 200 for broadcasting information is shown. The method 200 may be practiced with more or less than the number of steps shown. Moreover, the method 200 can be practiced by the components presented in FIG. 1 though is not limited to practice by the components shown. At step 201 the method can start. At step 202 the server 110 (See FIG. 1) can collect information from various sources for distribution to a plurality of mobile devices (140 and 142). For example, the server 110 may be a traffic server that collects information for various counties. The server 110 can collect traffic reports for each of the counties. At step 204, the server 110 can add context sensitive flags to the information to produce context information. For example, the server can add a flag to traffic information to identify a city, a street, a road, an intersection, or the like. At step 206, the server can broadcast the context information to the cellular network 100. For example, the server 110 can broadcast the information containing the flags to infrastructure components 120 and 122. Context information can include event broadcasts, location-based broadcasts, home land security broadcasts, priority broadcasts, emergency broadcasts, weather broadcasts, traffic broadcasts, channel subscription, entertainment broadcasts, or news broadcasts. The context sensitive flags can identify a geographic or semantic location to deliver the context sensitive information. A geographic location may identify a location of the mobile device by city, state, zip code, region, time zone, county, code, or country. A semantic location may identify a landmark, an area, a region, a route, a path, a name of a business, or the like. A context sensitive flag can be added to context information to inform an infrastructure component receiving the context information where to deliver the context information. The remaining method steps of FIG. 2 will be discussed ahead after a discussion of FIG. 3.

Briefly referring to FIG. 3, a schematic of the mobile device 140 is shown. The components of the mobile device 140 are representative of processing components associated with any device within the cellular communication system 100 of FIG. 1. Moreover, the mobile device 140 is not limited to the components shown, and can include more than the components shown. The mobile device 140 can be a radio, a cell phone, a personal digital assistant, a mobile communication device, a public safety radio, a portable media player, an emergency communication device, or any other suitable communication device.

The mobile device 140 can include a transmitter 141 for sending context information, a receiver 142 for receiving context information having context sensitive flags, a processor 143 for filtering the context information based on the context sensitive flags to produce context sensitive information, and a display 144 for presenting the context sensitive information. The mobile device 140 can also include a location detector 145, such as a global positioning system (GPS), for identifying a location of the mobile device 140. The location detector 145 can also identify a location of the mobile device based on a WLAN Internet Protocol address, a cellular traingulation, a loran, or any other means for determining a location. The transmitter 141 can send the location to an infrastructure component 120 which can use the location to generate location-based context sensitive information that is delivered to the mobile device 140.

As an example, infrastructure component 120 may be for Broward County and infrastructure components 122 may be for Palm Beach County. A mobile device receiving communication from a base station operated by one of the infrastructure components can receive context sensitive information from the infrastructure component. For example, mobile device 140 may be in Broward county within a cell cite of base station 130 operated by infrastructure component 120. The location detector 145 of the mobile device can inform the 140 infrastructure component of the mobile device's location 140.

Referring back to FIG. 2, at step 208, the infrastructure component 120 can filter the context information received by the server 110 based on the context sensitive flags to produce context sensitive information. For example, continuing with the traffic example, traffic information can be reported to the mobile device 140 based on a location of the mobile device 140. For example, infrastructure component 120 can identify a location of the device and filter traffic information received by the server 110 based on the location. At step 210, the infrastructure component 120 can send the context sensitive information to base station 130 operated by the at least one infrastructure component. In turn, the base station 130 can deliver the context sensitive information to the mobile device 140. For example, the base station 130 sends traffic information to the mobile device 140 pertaining to a location of the device.

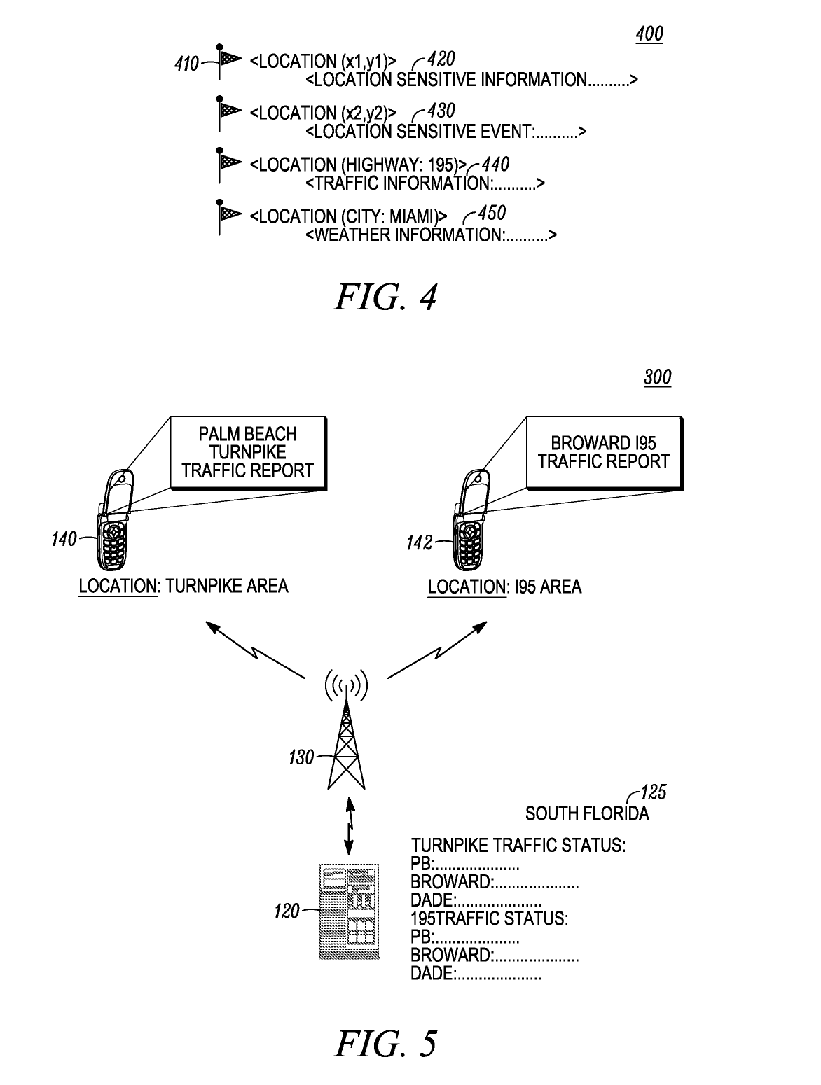

Briefly referring to FIG. 4, an example of context sensitive information is shown. Context sensitive information is context information that is identified by a flag, as one example, a flag can be a XML specific tag indicating the context, such as a context sensitive mark-up. As one example, the mark-up can be an XML component attached to XML data to identify information that can be filtered based on a context. For example, a context may be location based, time-based, priority-based, security-based, or event-based though is not herein limited to these. Location-based context information can be identified by latitude and longitude value, an area, cell infrastructure, or other form of positioning data. The location information can be included with the context information, and a flag can be associated with the location information. The flag may identify the location data or note. For example, a context sensitive flag 410 can identify a portion of context information that is location based. The flag 410 itself may be associated with the location data. For example, the flag may be a tag with special coding to identify a location (city, state, etc.) rather than providing coordinate data. The coding may also identify a priority. Alternatively, the coordinate data can be included with the context information if so desired. Notably, an infrastructure component (120) can parse the context information for location based information by searching for the specific location-based flag 410 in the context data. The infrastructure component can filter the context information based on a location of the mobile device 140.

Referring to FIG. 5 a location-based scenario is presented in the context of the cellular communication system 100. Location-based information can be generated in a central or distributed server 110. In one aspect, the server 110 can add the flags to the information to be broadcasted to generate context sensitive information which is then sent to the cellular network. The flags can identify an area, a coordinate, or a semantic location. If the context separation is performed in a distributed way, the infrastructure components 120 and 122 can remove the information concerning to the route and routed to the proper place. For example, the server collects traffic information which is broadcasted to the cellular network 100. The base stations 120 and 122 receive all the information, check the flags, filter the context sensitive information and route the context sensitive information to the proper base stations 130 or 132. In the case of higher resolution location (highway A and Highway B) when the infrastructure components 120 and 122 are incapable of filtering the flags (both locations are under the same infrastructure), the processing can be performed on the mobile device 140. The flags indicate an area to which the context information should be delivered. The context sensitive information broadcasted to the final user is filtered at the mobile device 140 to extract location-based information pertinent to the location of user. The mobile device 140 presents only the content concerning the cell site location. Understandably, the infrastructure component 120 may deliver additional information that may or may not be specific to the location. Accordingly, the mobile device 140 can further filter the information based on flags that do not correspond to the area. The filtered information can be displayed as a message to the end user.

As another example, context sensitive information can be event based. Location information can also be used for event broadcasting. For example, the broadcast server 110 (See FIG. 1) can send event information for a certain region, such as all of South Florida. Context sensitive flags can be added to indicate semantic city location, for example Miami, Fort Lauderdale, or other South Florida cities. The server 110 can send information associated with the event, for example, where the event is being held: American Airlines Arena, Office Depot Center, or Pompano Amphitheater. The mobile device 140 can receive the information and filter the information for presentation to the user. Moreover, information can be filter using different methods. For example, when the flag indicates Miami, then if the user is physically present in Miami (detected via GPS) Miami events are presented to the user. Also, the information can be presented to the user even though the user is not physically present in Miami if the user is allowing the flag. For example, the user can configure the mobile device 140 to receive location based or event based broadcasts. A tag with color special coding scheme can be included with the flags to identify a request. For example, blue flags allow the user to configure the filtering of information so the user can elect to receive or elect not to receive based on their request.

Blue flags may be soft flags; soft flags allow the user to select the information to be received. Moreover, if the user has been in the area identified by a flag, is planning to go the area identified by a flag, or is in a surrounding area, then relevant information regarding the history of the user's location can be presented. For example, if the user is in West Palm Beach broadcast events located in Miami can be sent to the user if the user is affiliated with the Miami area. For example, an affiliation may exist if the user has been in the area, is planning on going to the area, has friends in the area, or is interested on the type of broadcasted event to the area. That is, the user does not have to be physically present on the area to receive the event. Red flags may be hard flags. Red flags can presented to the user if the mobile device is in the location broadcasted. This type of filter is exclusively for the handset side filtering. Understandably, embodiments of the invention are not limited to only blue and red flags.

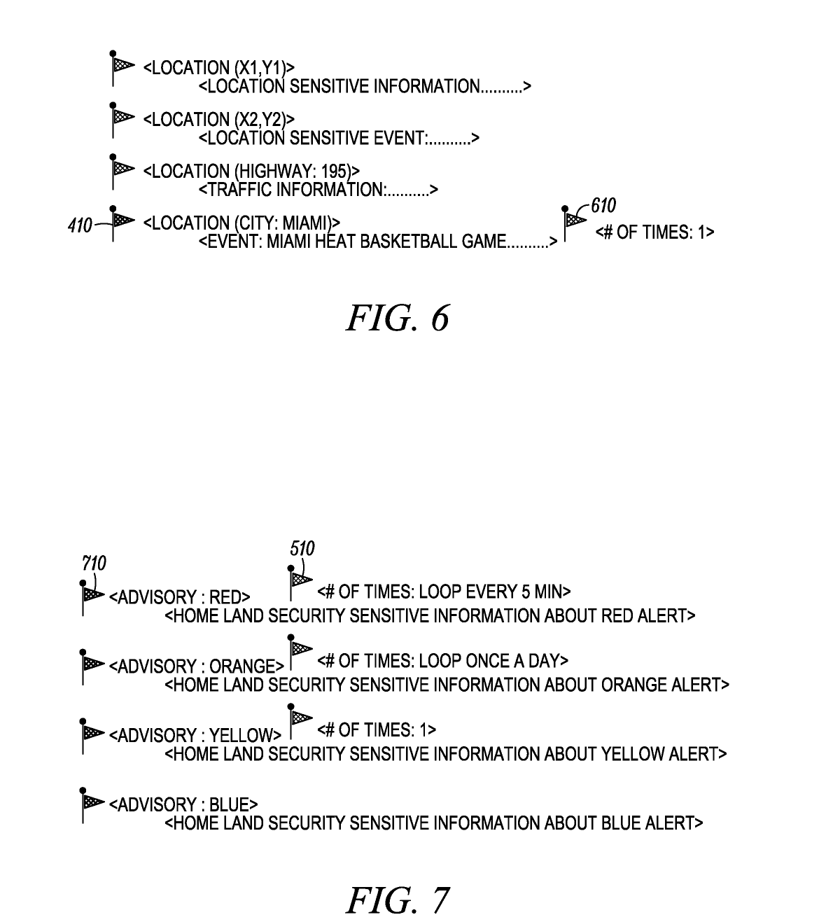

Other color coded tags and schemes are herein contemplated. For example, a flag can specify a repetition time for presentation of the flag. As another example, a flag can include a count for indicating a number of times the information has been presented. On may consider that an event may be broadcast repeatedly over a number of days, or that a recurring event may be broadcast such as an episode. Referring to FIG. 6, a flag 610 can identify a number of times that the information have to be presented to the user. For example, the location based information reported by flag 410 concerns a basketball event in Miami. The flag 610 identifies the number of times the event information has been presented to the user and also an expiration, for example when to stop displaying the information to the user. For the case of events or other items which the user chooses, only the first announcement is requested and granted to be displayed. Also the user can reset the flag so it can be received many times as a reminder.

As another example, context sensitive information can be security based for critical information. Briefly, referring back to FIG. 1, the server 110 can send all the critical information at once and let the mobile device 140 or infrastructure component 120 selects which information to choose. For example, information or events related to Homeland Security is considered critical. Understandably, critical level information can change over short periods of time. For example, an alert can change, between the time a server sends a critical broadcast and the time the user receives the information. In order to avoid processing delays at the infrastructure components, the server can deliver all the information at once. That is, the infrastructure components do not need to evaluate or filter critical information as the news may change and as people are moving between locations. The mobile device can then parse the received information to receive the most recent advisory. Referring to FIG. 7, the advisory flag 710 can be associated with various colors: red, yellow, orange, blue. The number of times flag 610 can also be set to loop, for the critical information so the user is alerted more often. The same flag 610 can be triggered by an event. That is, the flag 610 is conditional on an occurrence of an event such that the flag is raised if the event occurs, wherein the event is location-based or time-based. If the information is downloaded to the device, and only the orange alert was presented. Then if a change of the advisory is received, then the new information is presented to the user.

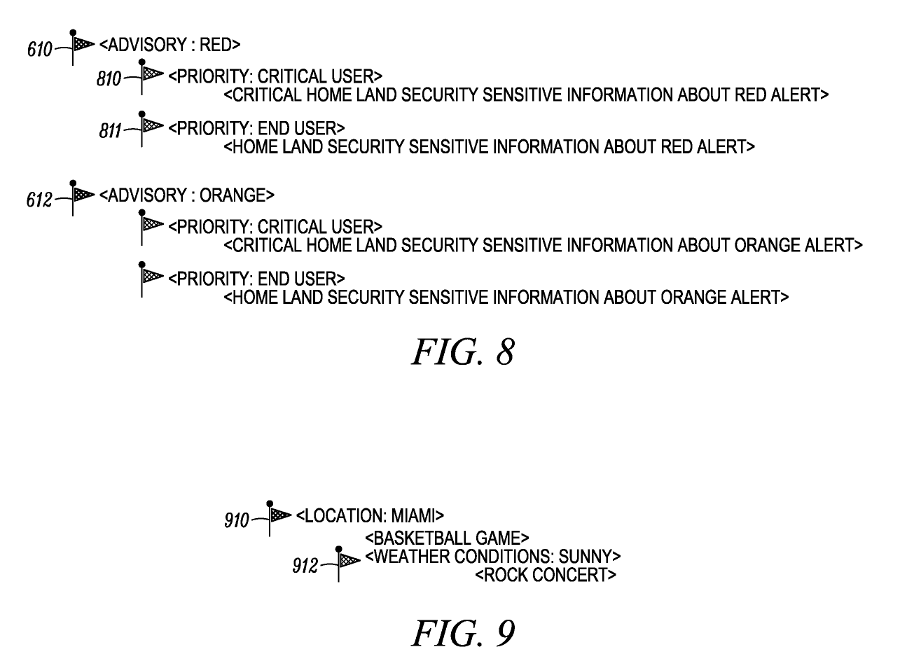

As another example, context sensitive information can be priority based; that is, information can also be sent or received using a priority tree. For example if the advisory flag 610 of FIG. 8 is sent to a critical user 810, such as a government organization, the information is presented only to those users. And only the information under regular user 811 is presented to the end user. That is, information can be flagged based on a user priority. For example, if the upper level flag 610 changes (from a color of orange 612 to red 611) then the filter points to the information under the red flag 610 and is distributed in accordance with the priority designated by the user flags 810 and 811.

The same priority designations addressed in FIG. 8 can be applied to all types of information which may not be priority related. As another example, referring to FIG. 9, the context information can be weather based information. Moreover, the weather information can be reported on a conditional basis. For example, a flag is conditional on an occurrence of an event such that the flag is raised if the event occurs. For example, if event information is being broadcasted, and if for any specific event a cancellation is possible due to rain, then a priority tree flag can indicate those events that need the condition to happen. A priority tree is a categorization of flags based on priority. For example, if under a Miami location flag 910 several events are being broadcasted, then all the events that require the weather to be Sunny can be broadcast under the respective condition. If the weather is fine, the filter ignores the flag 912, but if any sudden change is presented (rain) the flag 912 under the Sunny condition is filtered. Notably, the weather information can be flagged for identifying a distribution to certain locations depending on the severity of the weather condition. For example, critical weather information related to a certain area can be flagged for broadcast to devices in the area. Higher priorities can also be assigned to the weather flags based on a time of the event. For example, as the event nears a start time, the weather information can be prioritized. As another example, a time stamp can be added the formatting of the context sensitive information. Briefly referring back to FIG. 3, the receiver 141 may be scheduled to receive critical time information at a certain time slot. Accordingly, the receiver 141 rejects all the information that does not have the time stamp matching the user requirements. For example, information that is not within a time slot is rejected.

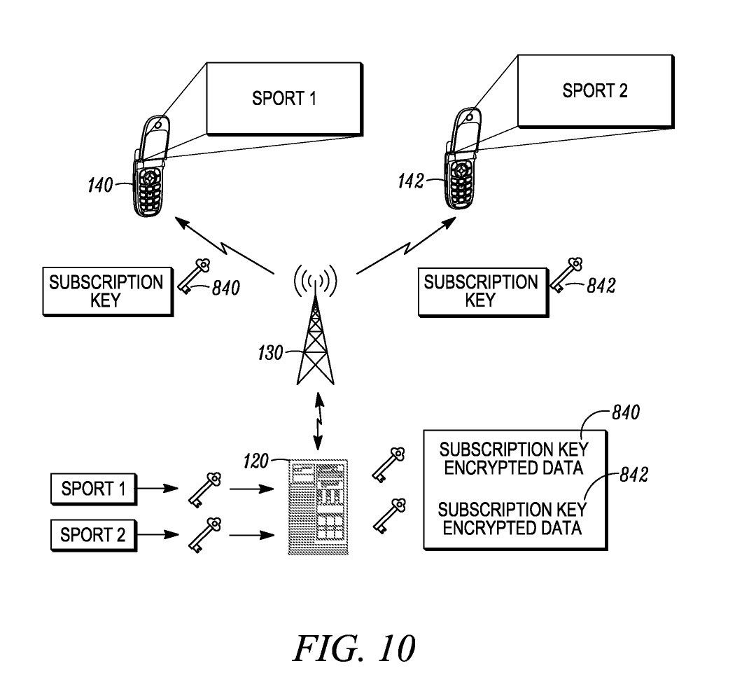

Embodiments of the invention are also directed to channel subscription services. In this aspect, the method 200 for flagging information to produce context sensitive information can be extended to subscription services. For example, a subscription service employing DVB-H can be employed to broadcast data in accordance with the method 200 and distributed to a plurality of mobile devices. The information distributed can include software updates, news, magazines, and the like. In one aspect, the user subscribes to the service to receive the channel, such as a news channel. Once the user subscribes to the channel, the mobile device can store a number that can be used to decode the broadcasted information. For example, referring to FIG. 4, the context sensitive information can be filtered based on the flags 410 to provide subscription services. For example, referring to FIG. 10, a user of the mobile device 140 may subscribe to multiple broadcasts, such as sports broadcasts. In one arrangement, the flag 410 (See FIG. 4) can identify secure context sensitive information. For example, the flag has a key associated to it 840 that unlocks a subscription broadcast. An infrastructure component 120, can include a key that can be encapsulated by a flag under a context “critical” entry. The context data, such as the sports broadcast, can be encrypted and delivered through the base station 130 to the mobile devices 140 and 142. Notably, only mobile devices have a key to the subscription can receive the broadcast. For example, mobile device 140 can decode the broadcast information with key 840 to receive sport 1. The, mobile device 142 can decode the same broadcast with key 842 to receive sport 2. Notably, the same broadcast is provided to the mobile devices. The mobile devices can unlock their subscription in the broadcast to receive their service or entertainment in accordance with the method 200 for flagging context sensitive information.

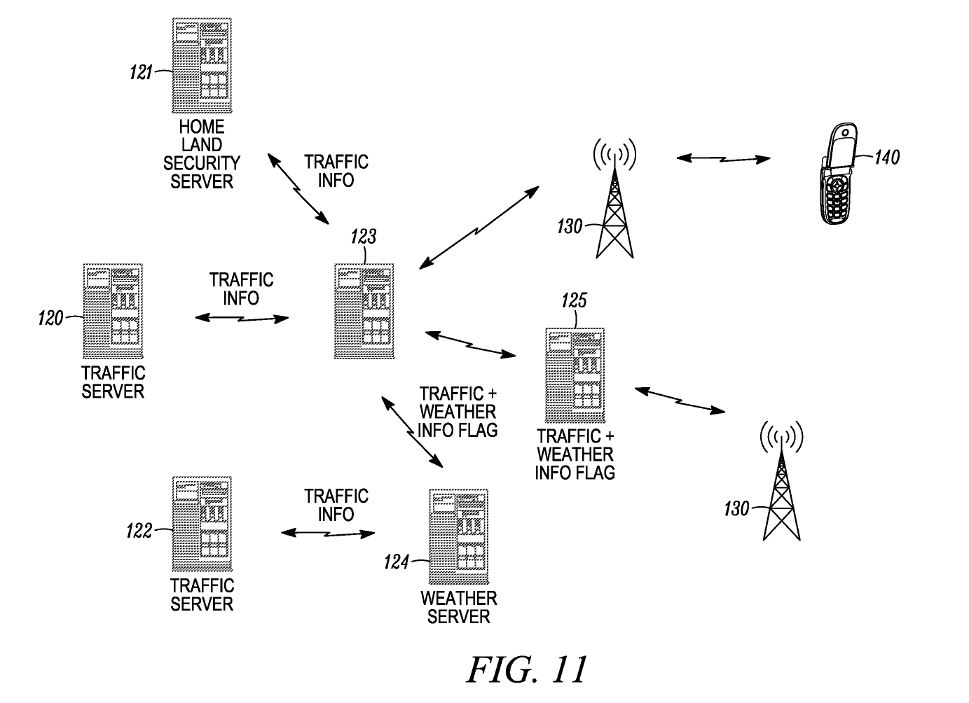

Referring to FIG. 11, another embodiment for delivering information in a cellular network is shown. The steps of method 200 (See FIG. 2) can be used to add or filter broadcasted information. In particular, when the information is broadcast, it can travel through different servers. The servers can remove and/or add more flags. Some server removes the location sensitive information about traffic, but can also add weather related information to the location flag. For example, traffic servers 120 and 122 may be reporting location-based traffic information to mobile device 140 through base station 130. The information may be channeled through a weather server 124 which may update the traffic information to include weather based information. Notably, the weather server 124 updates the context sensitive information using a flag structure presented in FIGS. 4, 6, 7, 8, 9. For example, flags can be introduced in the information using a priority tree flag structure, a color coded flag structure, or a conditional dependent flag structure as previously disclosed. As another example, server 125 collects traffic information and weather information from different locations and combines the data to produce context sensitive information. The server 125 can insert flags based on traffic and weather information relevant to the server location. As another example, a security server 121 can update or override context sensitive information generated by traffic servers 120 and 122. Each of the servers may be in direct communication with the base station 130, or there may be a central server 123 which collects the flag formatted context sensitive information and distributes the information to the mobile device 140.

In yet another embodiment of the invention, information can be shared between mobile devices in a non-network mode; that is, devices not having direct communication with a cellular network. For example, a plurality of devices in an ad-hoc network can communicate amongst one another to share information. A device can format data in accordance with the method 200 for generating context sensitive data. The context sensitive data can be distributed to peer nodes in the network which can perform the steps of filtering the information for context. Notably, information can be broadcast in an ad-hoc network that is delivered to all nodes. Those nodes interested in receiving specific data can filter the information based on the one or more types of flags. For example, devices within the same location can receive the same information, or devices in a location corresponding to an event can receive event related information. The information may be traffic information, weather information, local event information, local news, local advertisements, or emergency news. Notably, a mobile device can send context sensitive information to devices in an ad-hoc network not having immediate communication with the cellular network. As an example, a transmitter of the mobile devices may operate over a WLAN connection or a Bluetooth connection or short range transmission communications such as Mototalk.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention are not limited. Numerous modifications, changes, variations, substitutions and equivalents will occur to those skilled in the art without departing from the spirit and scope of the present embodiments of the invention as defined by the appended claims.

What is claimed is:

1. A method for information broadcasting, comprising:
generating information for distribution to a plurality of mobile devices;
adding context sensitive flags to the information to produce context information;
broadcasting the context information to an infrastructure having communication with the plurality of mobile devices;
filtering the context information based on the context sensitive flags to produce context sensitive information; and
presenting the context sensitive information to at least one of the plurality of mobile devices.

2. The method of claim 1, wherein a context sensitive flags identify a geographic or semantic location to deliver the context sensitive information.

3. The method of claim 1, wherein a flag is conditional on an occurrence of an event such that the flag is raised if the event occurs, wherein the event is location-based or time-based.

4. The method of claim 1, further comprising identifying a context sensitive flag by a priority and a color associated with the priority.

5. The method of claim 1, further comprising specifying a repetition time for presenting an alert flag.

6. The method of claim 1, wherein the broadcasting is at least one of event broadcasting, location-based broadcasting, home land security broadcasting, priority broadcasting, emergency broadcasting, weather broadcasting, traffic broadcasting, channel subscription, entertainment broadcasting, or news broadcasting.

7. A system for information broadcasting, comprising:
a server for
collecting information for distribution to a plurality of mobile devices;
adding context sensitive flags to the information to produce context information; and
broadcasting the context information to the cellular network,
at least one infrastructure component in the cellular network for
receiving the context information;
filtering the context information based on the context sensitive flags to produce context sensitive information; and
sending the context sensitive information to at least one base station operated by the at least one infrastructure component, and
at least one base station in the cellular network for
delivering the context sensitive information to the plurality of mobile devices.

8. The system of claim 7, further comprising:
at least one mobile device in the plurality of mobile devices for
filtering the context sensitive information based on the context sensitive flags; and
presenting the context sensitive information to the at least one mobile device,
wherein the at least one mobile device identifies a location of the mobile device.

9. The system of claim 8, wherein the at least one infrastructure component sends location sensitive information to the at least one mobile device based on a location of the device.

10. The system of claim 8, wherein the at least one infrastructure component sends event sensitive information to the at least one mobile device based on events occurring within a location of the device.

11. The system of claim 8, wherein rendering the context sensitive information presents information associated with a cell site region of the infrastructure component.

12. The system of claim 11, wherein the information is traffic information, weather information, local event information, local news, local advertisements, or emergency news.

13. The system of claim 7, wherein an infrastructure component performs the filtering by one of city, state, zip code, region, time zone, county, code, or country.

14. The system of claim 7, wherein an infrastructure component sends a message that is formatted with context sensitive flags such that a mobile device can selectively filter the context sensitive information based on user input.

15. The system of claim 7, wherein at least one infrastructure component adds content and context sensitive flags to context information delivered throughout the cellular network.

16. A mobile device for information broadcasting, comprising:
a transmitter for sending context information;
a receiver for receiving context information having context sensitive flags;
a processor for filtering the context information based on the context sensitive flags to produce context sensitive information; and
a display for presenting the context sensitive information.

17. The mobile device of claim 16, further comprising:
a global positioning system for identifying a location of the mobile device,
wherein the transmitter sends the location to an infrastructure component that uses the location to generate location-based context sensitive information that is delivered to the mobile device.

18. The mobile device of claim 17, wherein the transmitter can send context sensitive information to devices in an ad-hoc network not having immediate communication with the cellular network.

19. The mobile device of claim 17, wherein the transmitter operates over a WLAN connection or a Bluetooth connection.

20. The mobile device of claim 17, wherein the context sensitive information is one of broadcast information, location-based information, home land security information, priority information, emergency information, weather information, traffic information, channel subscription, or news.
